(19) United States
(12) Patent Application Publication
(10) Pub. No.: US 2025/0122013 A1
(43) Pub. Date: Apr. 17, 2025

(54) Article Transport Facility

(71) Applicant: Daifuku Co., Ltd., Osaka-shi (JP)

(72) Inventors: Toru Konagaya, Hinocho (JP); Akira Takeuchi, Hinocho (JP)

(21) Appl. No.: 18/916,875

(22) Filed: Oct. 16, 2024

(30) Foreign Application Priority Data
Oct. 17, 2023 (JP) 2023-178901

(51) Int. Cl. B65G 1/04

(52) U.S. Cl. CPC B65G 1/0492

(57) ABSTRACT

In an article transport facility, a control system includes a first stop mode and a second stop mode each being a stop mode in which a plurality of transport vehicles do not transport articles. The first stop mode is a mode in which the plurality of transport vehicles are arranged in a plurality of lines, at least one aisle on which the plurality of transport vehicles are travelable is defined between adjacent lines of the plurality of lines of the plurality of transport vehicles, and all transport vehicles of the plurality of transport vehicles in each of the plurality of lines are adjacent to the at least one aisle. The second stop mode is a mode in which the plurality of transport vehicles are proximate to each other without the at least one aisle.

### CROSS-REFERENCE TO RELATED APPLICATION

This application claims priority to Japanese Patent Application No. 2023-178901 filed Oct. 17, 2023, the disclosure of which is hereby incorporated by reference in its entirety.

### BACKGROUND OF THE INVENTION

### Field of the Invention

The present invention relates to an article transport facility in which multiple transport vehicles transport articles.

### Description of Related Art

Recent article transport facilities such as distribution warehouses have automated article transport systems. For example, Japanese Unexamined Patent Application Publication No. 2000-128318 (JP 2000-128318) describes an article transport facility in which multiple transport vehicles (cage carts 2) transport articles (W).

In the article transport facility shown in FIG. 1 of JP 2000-128318, the articles (W) are transferred between multiple storage shelves (7) arranged adjacent to a circulating transport path (F) in the form of a track and the multiple transport vehicles (2) traveling on the circulating transport path (F) in the form of a track. For example, for more types of articles or for more sorting destinations of the articles, the article transport facility may include multiple circulating transport paths (F). In this case, in response to an increase in the number of circulating transport paths (F), the number of transport vehicles (2) increases. Thus, maintenance of the floor on which the transport vehicles (2) travel and maintenance of the transport vehicles (2) are to be performed efficiently. However, J P 2000-128318 does not particularly describe any method for performing the maintenance of the transport vehicles (2) and the floor efficiently.

### SUMMARY OF THE INVENTION

One or more aspects are directed to an article transport facility that allows the maintenance of the transport vehicles and the floor to be performed efficiently.

An article transport facility according to an aspect of the disclosure is an article transport facility in which a plurality of transport vehicles travel on a floor to transport articles. The article transport facility includes a control system that controls the plurality of transport vehicles. The control system includes a first stop mode and a second stop mode each being a stop mode in which the plurality of transport vehicles do not transport the articles. The first stop mode is a mode in which the plurality of transport vehicles are arranged in a plurality of lines. At least one aisle on which the plurality of transport vehicles are travelable is defined between adjacent lines of the plurality of lines of the plurality of transport vehicles. All transport vehicles of the plurality of transport vehicles in each of the plurality of lines are adjacent to the at least one aisle. The second stop mode is a mode in which the plurality of transport vehicles are proximate to each other without the at least one aisle between the adjacent lines.

In this structure, the aisle is defined between the adjacent lines of the transport vehicles in the first stop mode. This allows, for example, the transport vehicles to move on the aisle for charging or an operator to move on the aisle for the maintenance of the transport vehicles. This facilitates the maintenance of the transport vehicles. In the second stop mode, the plurality of transport vehicles are proximate to each other, thus reducing an area on the floor in which the transport vehicles being stopped are arranged. This facilitates the maintenance of the floor. In this structure, as described above, in the stop modes in which the plurality of transport vehicles do not transport the articles, the transport vehicles can be arranged and stopped in different arrangement patterns based on, for example, the details of an operation, such as maintenance, performed by the operator or whether the transport vehicles are to be charged. The stop modes can thus be used more effectively.

### BRIEF DESCRIPTION OF THE DRAWINGS

The terms Fig., Figs., Figure, and Figures are used interchangeably in the specification to refer to the corresponding figures in the drawings.

FIG. 1 is a top view of an article transport facility according to a first embodiment.

FIG. 2 is a front view of an aisle area in FIG. 1.

FIG. 3 is a control block diagram of the article transport facility in FIG. 1.

FIG. 4 is a diagram of a first layer of a floor in FIG. 1 in a first stop mode.

FIG. 5 is a diagram of a second layer of the floor in FIG. 1 in the first stop mode.

FIG. 6 is a diagram of the first layer of the floor in FIG. 1 in a second stop mode.

FIG. 7 is a diagram of the second layer of the floor in FIG. 1 in the second stop mode.

FIG. 8 is a diagram of an article transport facility according to a second embodiment in the first stop mode.

FIG. 9 is a diagram of the article transport facility according to the second embodiment in the second stop mode.

FIG. 10 is a front view of an aisle area in the second embodiment.

### DESCRIPTION OF THE INVENTION

An article transport facility according to a first embodiment will be described below with reference to the drawings.

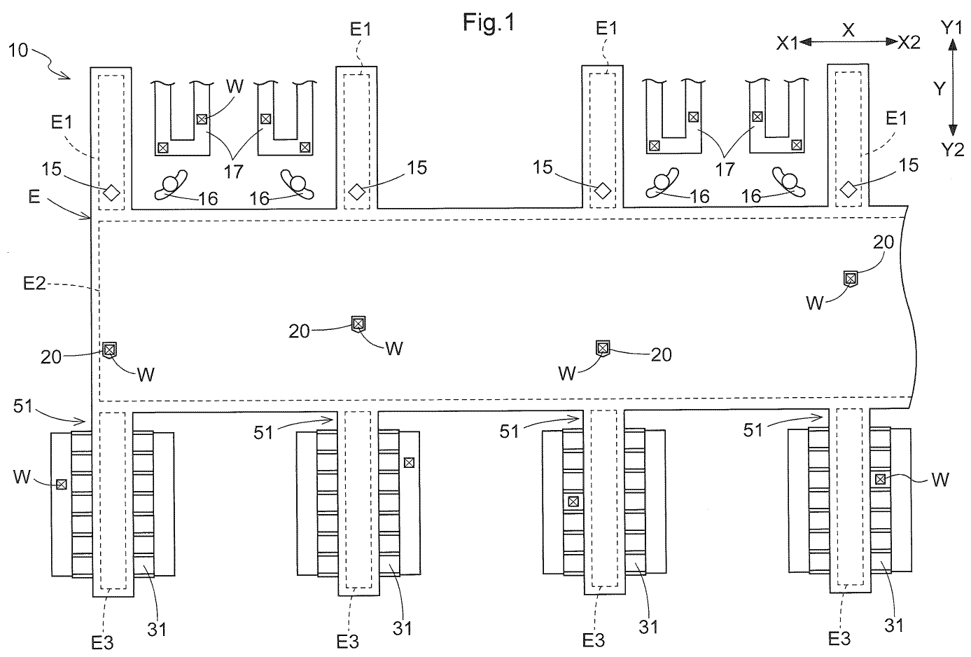

FIG. 1 is a top view of an article transport facility 10 in which multiple transport vehicles 20 travel on a floor E to transport articles W. The article transport facility 10 according to the present embodiment is an article sorting facility in which the multiple transport vehicles 20 transport the articles W to sort the articles W. The article transport facility 10 includes the transport vehicles 20, the floor E, supply units 15 that supply the articles W to the transport vehicles 20, and multiple receivers 31. The multiple receivers 31 receive the articles W from the transport vehicles 20.

An operating entity 16 transfers articles W to transport vehicles 20 at each supply unit 15. The operating entity herein refers to, for example, an operator, an operating device, or both. The operating entity 16 transfers the articles W from a supply transporter 17 to the transport vehicles 20. The supply transporter 17 transports the articles W from an automated warehouse (not shown). Examples of the supply transporter 17 include a belt conveyor, a crane, and a robotic arm.

A specific direction along the floor E is herein referred to as a Y-direction. A direction along the floor E and perpendicular to the Y-direction is referred to as an X-direction. One side in the Y-direction is referred to as a first side Y1 in the Y-direction, and the other side in the Y-direction is referred to as a second side Y2 in the Y-direction. One side in the X-direction is referred to as a first side X1 in the X-direction, and the other side in the X-direction is referred to as a second side X2 in the X-direction. The vertical direction is referred to as a Z-direction. Examples of the floor E include travel surfaces on which vehicles travel and floors in buildings, ships, and other facilities. In the present embodiment, the floor E is a travel surface on an indoor platform.

The floor E includes supply areas E1 with the supply units 15 and aisle areas E3 extending in the Y-direction. The supply areas E1 are arranged on the first side Y1 in the Y-direction relative to the aisle areas E3. The multiple aisle areas E3 are arranged in the X-direction. The floor E includes a connection area E2 connecting the multiple aisle areas E3 and the supply areas E1. The supply areas E1, the connection area E2, and the aisle areas E3 on the floor E may each be actually-divided areas or virtually-defined areas on the floor E. In the present embodiment, the boundaries between the supply areas E1 and the connection area E2 are virtual boundaries defined on the floor E. In the present embodiment, each aisle area E3 has its two ends in the X-direction that are the outer edges of the floor E.

The connection area E2 connects the supply areas E1 and the aisle areas E3 to allow the transport vehicles 20 to travel between the areas. The aisle areas E3 have first ends 51 on the first side Y1 in the Y-direction. The connection area E2 connects the first ends 51 of the aisle areas E3 and the supply areas E1.

The multiple aisle areas E3 are arranged in the X-direction on the floor E. The first ends 51 of the aisle areas E3 are connected to one another with the connection area E2 between them. The multiple receivers 31 are arranged along the multiple aisle areas E3. The article transport facility 10 includes the multiple supply units 15. The multiple supply areas E1 each including the supply unit 15 are arranged in the X-direction on the floor E.

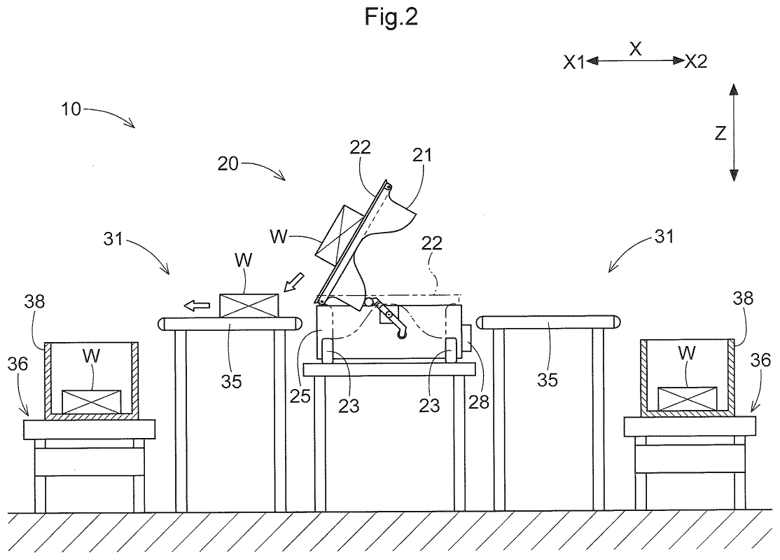

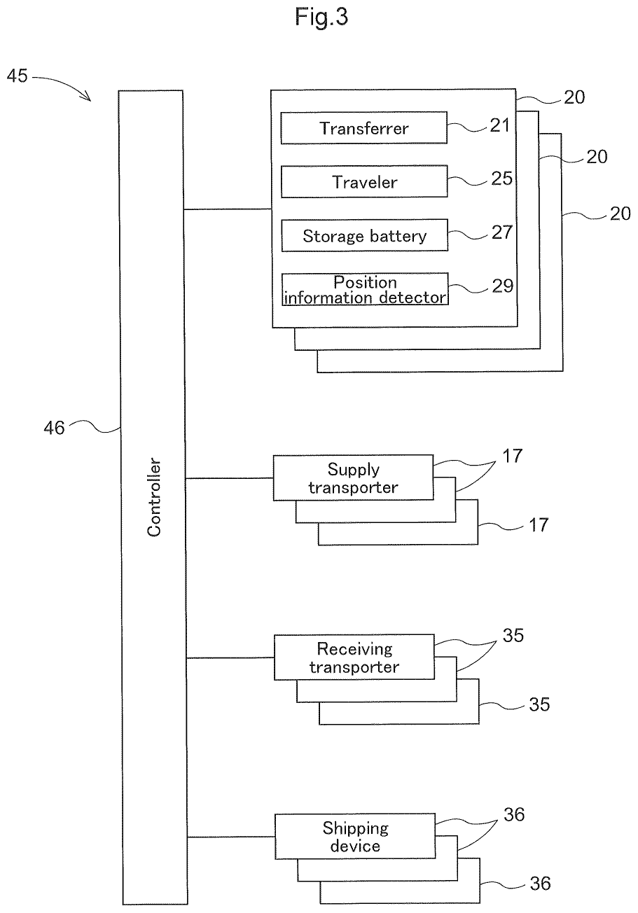

FIG. 2 is a front view of an aisle area E3. The aisle area E3 has the two ends in the X-direction along which multiple receivers 31 are arranged in the Y-direction. Each transport vehicle 20 includes a transferrer 21 that transfers an article W from the transport vehicle 20 to a receiver 31. The transferrer 21 has a receiving surface 22 on which the article W is placeable. The receiving surface 22 is switchable between a horizontal orientation and a tilting orientation. While being transported, the article W is placed on the receiving surface 22 in the horizontal orientation. When the receiving surface 22 is in the tilting orientation, the article W is transferred to the receiver 31. Each transport vehicle 20 includes a traveler 25. The traveler 25 includes multiple wheels 23 that roll on the travel surface on the floor E. Examples of the transport vehicles 20 include electric vehicles that travel on electricity supplied from storage batteries or fuel cells, or through contact or contactless power feed from the floor E and include vehicles with internal combustion engines. In the present embodiment, the traveler 25 in each transport vehicle 20 incorporates a storage battery 27 (refer to FIG. 3). In the present embodiment, the transport vehicles 20 are electric automatic guided vehicles.

Each transport vehicle 20 includes an operable unit 28 operable by the operating entity. Examples of the operable unit 28 in each transport vehicle 20 include a switch, a connector, and a touchscreen. Each transport vehicle 20 may include a cover for covering, for example, the switch, the connector, or the touchscreen, as well as a receiving space for an article W. The operable unit 28 may be operable by the operating entity to attach and detach or open and close the cover. In the present embodiment, the operable unit 28 is operable by an operator who performs maintenance.

Each of the multiple receivers 31 includes a receiving transporter 35. Articles W transferred to the receivers 31 are transported in the X-direction by the receiving transporters 35 to be placed in containers 38 for the respective receivers 31. In the present embodiment, the receiving transporters 35 are adjacent to shipping devices 36. The containers 38 are arranged on the shipping devices 36. When articles W of a type and in a quantity specified in one piece of order information are placed in a container 38, the corresponding shipping device 36 transports the container 38 to a shipping location. Examples of the receiving transporters 35 include belt conveyors, cranes, and robotic arms. Examples of the shipping devices 36 include belt conveyors, stacker cranes, and automatic guided vehicles.

FIG. 3 is a control block diagram of the article transport facility 10 according to the present embodiment. The article transport facility 10 includes a control system 45 that controls the transport vehicles 20. In the example in the figure, the control system 45 includes a controller 46 that controls the transferrer 21 and the traveler 25 in each transport vehicle 20, the supply transporters 17, the receiving transporters 35, and the shipping devices 36. The controller 46 includes an arithmetic processor such as a central processing unit (CPU) and a main storage such as a random-access memory (RAM) or a read-only memory (ROM) that can be referenced by the arithmetic processor. The functions of the controller 46 (e.g., the function of controlling the travel of the transport vehicles 20) are implemented by the hardware in the controller 46 cooperating with a program executed on the arithmetic processor or other pieces of hardware. More specifically, each function of the controller 46 is implemented by the controller 46 executing a program stored in a storage (e.g., the main storage or a storage separate from the main storage). In other words, the program (e.g., an article transport program) for causing a computer (a computer in the control system 45) to implement the functions of the controller 46 is stored in a storage that can be referenced by the computer. The program is provided by, for example, a storage medium or through a communication network. The provided program is then stored into the storage that can be referenced by the computer. In the present embodiment, the controller 46 (more specifically, the arithmetic processor in the controller 46) functions as the computer. The controller 46 may be a set of multiple pieces of hardware (multiple separate pieces of hardware) that can communicate with one another through wires or wirelessly, rather than a single piece of hardware. For example, the controller 46 may include a host controller disposed in a control facility (not shown) to control the transport vehicles 20 and controllers mounted on the respective transport vehicles 20.

The floor E is divided into multiple virtual subareas Au in a grid as viewed in the Z-direction. Travel paths for the transport vehicles 20 connect any number of virtual subareas Au to one another. In the present embodiment, each transport vehicle 20 includes a position information detector 29 (refer to FIG. 3). Each virtual subarea Au includes a position information holder. When the transport vehicles 20 travel on the travel paths, the position information detector 29 in each transport vehicle 20 detects position information held by the position information holder in each virtual subarea Au. Examples of the position information holder include a barcode (one-dimensional code), a two-dimensional code, and a radio-frequency identification tag. The position information detected by the position information detector 29 is transmitted from each transport vehicle 20 to the controller 46 in the control system 45.

The control system 45 provides, for example, a transport command to each transport vehicle 20. The transport command specifies the source and the destination of an article W. In the present embodiment, the source is one of the supply units 15. The destination is one of the receivers 31. The transport command specifies the travel path for the transport vehicle 20 to travel from the source to the destination. Upon receiving the transport command from the control system 45, the transport vehicle 20 receives an article W at the specified source and transports the article W to the specified destination.

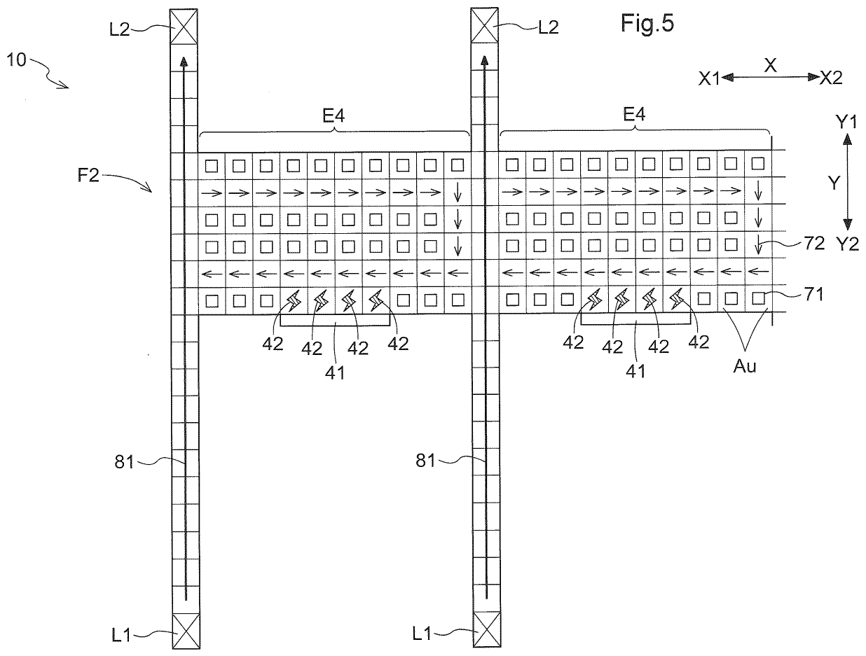

The transport command in the present embodiment defines an outgoing path for a transport vehicle 20 to travel from one of the supply units 15 to a terminal end of one of the aisle areas E3. The transport command in the present embodiment defines a return path for the transport vehicle 20 to travel from the terminal end of the aisle area E3 to one of the supply units 15. In the present embodiment, the return path is one of return aisles 81 (refer to FIG. 5) described later. In the present embodiment, the terminal end of the aisle area E3 is an end of the aisle area E3 on the second side Y2 in the Y-direction.

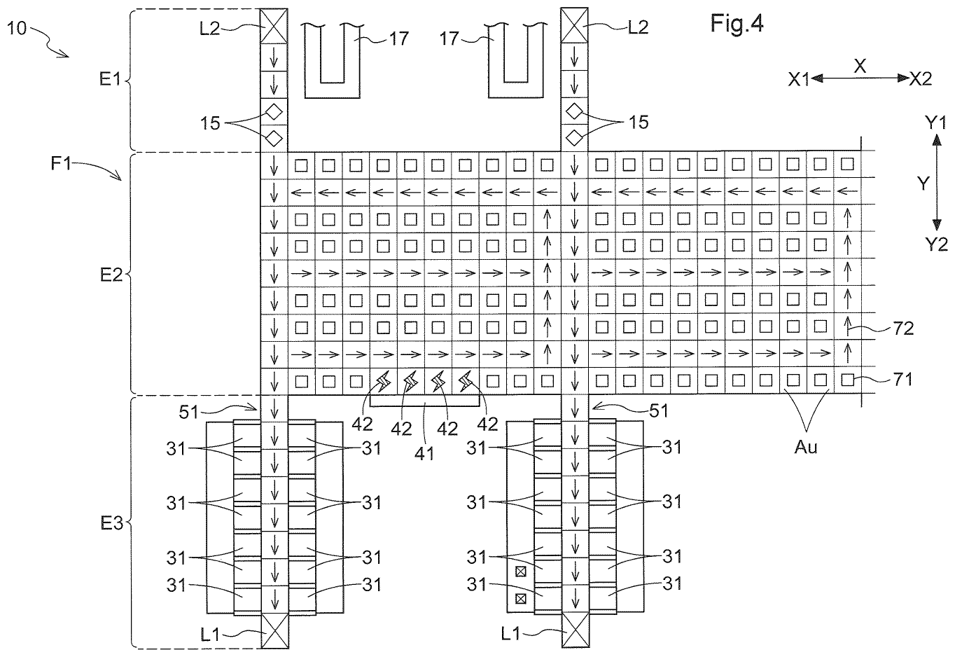

FIG. 4 is a diagram of a first layer F1 in the article transport facility 10. The connection area E2 includes charging positions 42 for charging the transport vehicles 20 with a charger 41. This allows efficient use of the connection area E2, which includes no supply unit 15 and no receiver 31. In the example in the figure, the charger 41 is disposed adjacent to the connection area E2. The charging positions 42 are arranged to allow multiple transport vehicles 20 to stop at the charging positions 42.

Each transport vehicle 20 moves to and stops at a charging position 42 when the remaining battery level is less than a predetermined level (e.g., less than 50% of the full capacity). At the charging position 42, the storage battery 27 (refer to FIG. 3) in the transport vehicle 20 can be charged rapidly. The charger 41 may be a contactless power feeder or a contact power feeder. In the present embodiment, the controller 46 included in the control system 45 (described later) obtains the remaining level of the storage battery 27 in each transport vehicle 20 and controls any transport vehicle 20 with less than a predetermined battery level to move to the charging position 42.

FIG. 5 is a diagram of a second layer F2 in the article transport facility 10. The floor E includes the first layer F1 and the second layer F2 at different levels in the Z-direction (vertical direction). In the present embodiment, the first layer F1 and the second layer F2 are adjacent to each other in the Z-direction. Although the second layer F2 is disposed above the first layer F1 in the present embodiment, the second layer F2 may be below the first layer F1. In the present embodiment, the first layer F1 includes the supply areas E1, the connection area E2, and the aisle areas E3.

The article transport facility 10 includes first lifters L1 that transport the transport vehicles 20 in the Z-direction. The first lifters L1 are connected to the aisle areas E3 in the first layer F1 and to the second layer F2. In the example in the figures, the first lifters L1 are connected to the terminal ends of the aisle areas E3 and to the second layer F2. The article transport facility 10 includes second lifters L2 that transport the transport vehicles 20 in the Z-direction. In the example in the figures, the second lifters L2 are connected to the supply areas E1 in the first layer F1 and to the second layer F2. The first lifters L1 and the second lifters L2 are spaced from each other in the horizontal direction.

The first lifters L1 and the second lifters L2 are connected by the return aisles 81 (described later) on the second layer F2 to allow the transport vehicles 20 to travel. In the example in the figures, the second lifters L2 are connected to the return aisles 81 and to the first layer F1. The first lifters L1 and the second lifters L2 may be directly or indirectly connected to the return aisles 81. The first lifters L1 may be directly or indirectly connected to the aisle areas E3. The second lifters L2 may be directly or indirectly connected to the supply areas E1. The first lifters L1 and the second lifters L2 may each autonomously transport the transport vehicles 20 or may each be controlled by the control system 45. Examples of the first lifters L1 and the second lifters L2 include devices that circulate multiple lifting tables along a predetermined annular path to lift and lower the transport vehicles 20, multicopters that can transport the transport vehicles 20, and elevators.

The second layer F2 includes the return aisles 81 on which the transport vehicles 20 travel. The first lifters L1 are connected to starting ends of the return aisles 81 and to the terminal ends of the aisle areas E3. The second lifters L2 are connected to terminal ends of the return aisles 81 and to the supply areas E1. In the example in the figure, the multiple return aisles 81 are arranged on the second layer F2 and each extend in the Y-direction. After transporting the articles W to the receivers 31 in the aisle areas E3, the transport vehicles 20 travel on the return aisles 81. In the present embodiment, the transport vehicles 20 are not allowed to stop on the return aisles 81. In the example in the figure, the return aisles 81 are one-way.

The second layer F2 includes aisle connection areas E4 to allow the transport vehicles 20 to travel between the multiple return aisles 81. In the example in the figure, each aisle connection area E4 is disposed between return aisles 81 adjacent to the aisle connection area E4 in the X-direction. The aisle connection areas E4 include the charging positions 42 for charging the transport vehicles 20. The aisle connection areas E4 include stoppable areas 71 (described later). The aisle connection areas E4 include travelable areas 72 (described later).

The control system 45 performs, at each receiver 31, a batch process of receiving articles W of a type and in a quantity specified in one piece of order information. The control system 45 performs, at each receiver 31, a first batch process of receiving articles W of a type and in a quantity specified in one piece of order information, and then performs a second batch process of receiving articles W of a type and in a quantity specified in another piece of order information. In the present embodiment, one container 38 is used for one piece of order information. The control system 45 places the articles W of the type and in the quantity specified in one piece of order information in the first batch process into a container 38 (refer to FIG. 2) adjacent to the receiver 31. When the first batch process is complete, or in other words, when all the articles W of the type and in the quantity specified in one piece of order information is placed in the container 38, the container 38 is transported to the shipping location. Another container 38 corresponding to the other piece of order information is then placed adjacent to the receiver 31. The control system 45 places the articles W of the type and in the quantity specified in the other piece of order information in the second batch process into the other container 38.

The control system 45 includes a first stop mode and a second stop mode as stop modes in which the multiple transport vehicles 20 do not transport the articles W. For the stop modes in the present embodiment, arrangement patterns for the multiple transport vehicles 20 are different between the first stop mode and the second stop mode. In each stop mode, all the transport vehicles 20 in the article transport facility 10 may not transport the articles W. In each stop mode, some of the transport vehicles 20 in the article transport facility 10 may not transport the articles W, and the other transport vehicles 20 may transport the articles W.

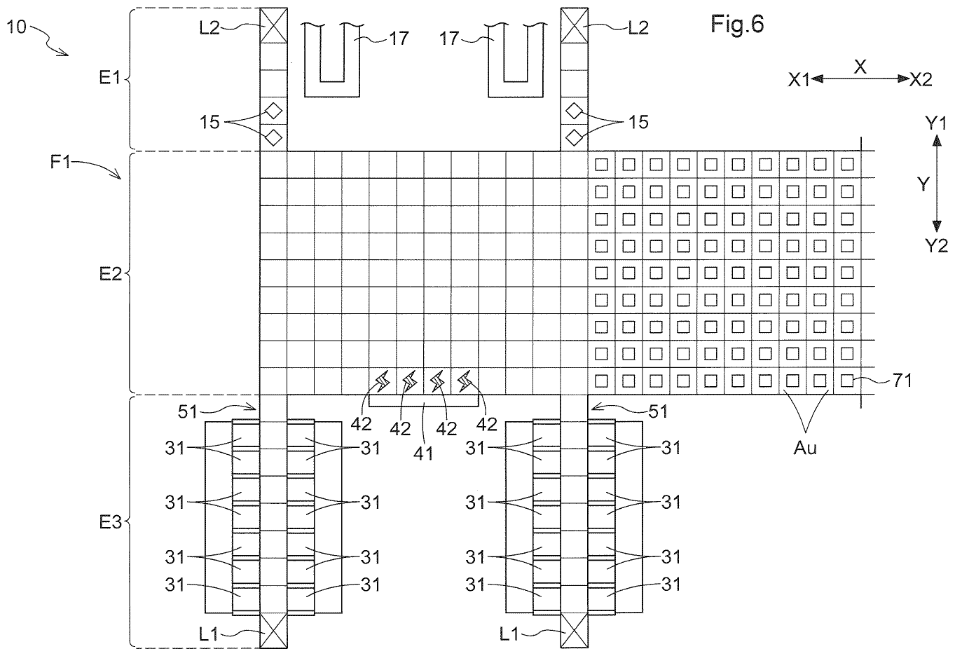

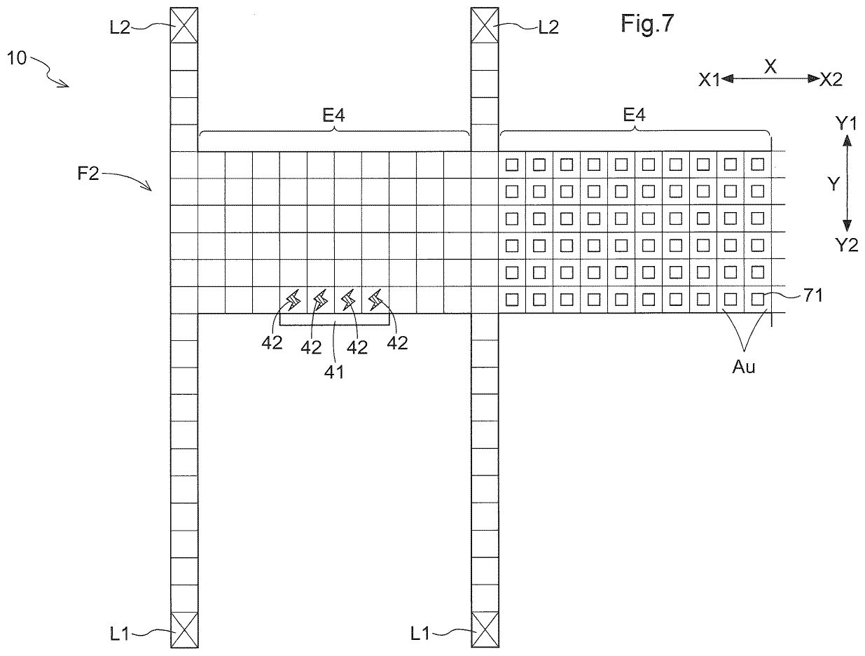

FIGS. 4 and 5 show the arrangement pattern in the first stop mode. FIGS. 6 and 7 show the arrangement pattern in the second stop mode. The arrangement pattern herein refers to a shape formed by the stoppable areas 71 for the multiple transport vehicles 20 as viewed in the Z-direction. The floor E includes the stoppable areas 71 in which the transport vehicles 20 can stop in the first stop mode or the second stop mode, and the travelable areas 72 in which the transport vehicles 20 are not allowed to stop. In the example in the figures, the virtual subareas Au with a square are the stoppable areas 71, and the virtual subareas Au with an arrow are the travelable areas 72. In the present embodiment, one transport vehicle 20 stops in one stoppable area 71. The travelable areas 72 are one-way. The travelable areas 72 may be changeable by the control system 45 or the operator, or may not be changeable. Although transport vehicles 20 are stopped in all the stoppable areas 71 in the example described below, transport vehicles 20 may not be stopped in some of the stoppable areas 71.

As shown in FIGS. 4 and 5, in the first stop mode in the present embodiment, the multiple transport vehicles 20 are arranged in multiple lines, and the aisles on which the transport vehicles 20 are travelable are each defined between adjacent lines of the multiple transport vehicles 20. All transport vehicles 20 in each line are adjacent to at least one of the aisles. In the present embodiment, the stoppable areas 71 are arranged, in the first stop mode, to define the travel paths connecting the aisles each between adjacent lines of the transport vehicles 20 to the charging positions 42. In the first stop mode, each transport vehicle 20 is disposed with its operable unit 28 adjacent to the aisle. In the example in the figures, the aisles on which the transport vehicles 20 are travelable in the first stop mode are indicated by the travelable areas 72. In the example in the figures, all the stoppable areas 71 are adjacent to at least one of the travelable areas 72.

In the first stop mode, at least one of the transport vehicles 20 is in the connection area E2. The control system 45 may use a part of the connection area E2 as an arrangement area in which some of the transport vehicles 20 and the aisles are arranged in the first stop mode, and may use the other part of the connection area E2 as a transport area in which the other transport vehicles 20 transport the articles W. In this case, the operator can perform the maintenance of multiple transport vehicles 20, and the articles W can be transported normally in the other part of the connection area E2 at the same time.

The control system 45 automatically selects the first stop mode in response to the end of the transportation of the articles W by the transport vehicles 20. The transportation of the articles W by the transport vehicles 20 ends in response to, for example, an instruction to stop the transportation for a periodic suspension of the article transport facility 10, an instruction to stop the transportation due to a power failure or an earthquake, or an instruction to stop the transportation from the operator in charge of the maintenance in which maintenance targets are not specified.

The control system 45 arranges the travelable areas 72 to allow a transport vehicle 20 that receives an article W at a supply unit 15 to transport the article W to any of the multiple receivers 31 in the first stop mode. The control system 45 arranges the travelable areas 72 to allow the transport vehicle 20 that has transported the article W to a receiver 31 in an aisle area E3 to return to the supply unit 15 in the first stop mode. This allows the operator to perform the maintenance of multiple transport vehicles 20, and allows, at the same time, multiple transport vehicle 20 to transport articles W from the supply units 15 to the receivers 31 to sort the articles W.

As shown in FIGS. 6 and 7, in the second stop mode in the present embodiment, the multiple transport vehicles 20 are proximate to each other without the aisles between the adjacent lines. Although the travelable areas 72 are not arranged in the example in the figures, the travelable areas 72 may be arranged in areas other than the stoppable areas 71. In the second stop mode, in an arrangement area in which the multiple stoppable areas 71 are proximate to each other, the stoppable areas 71 other than the stoppable areas 71 arranged along the outer edge of the area are not adjacent to the travelable areas 72. In the second stop mode, the control system 45 can change, in response to an instruction from the operator, the arrangement area in which the multiple transport vehicles 20 are proximate to each other.

In the second stop mode, the control system 45 uses a part of the connection area E2 as the arrangement area in which the multiple transport vehicles 20 are proximate to each other. The control system 45 divides (e.g., equally divides) the connection area E2 into multiple parts, and uses one of the multiple parts as the arrangement area in which the multiple transport vehicles 20 are proximate to each other. For example, when the control system 45 equally divides the connection area E2 into two parts and uses one of the two parts as the arrangement area, the operator performs the maintenance of the other half of the connection area E2 that is not the arrangement area. The operator then provides an instruction to change the arrangement area to perform the maintenance of the remaining half of the connection area E2.

As shown in FIG. 6, in the second stop mode, at least one of the transport vehicles 20 is in the connection area E2. As shown in FIG. 5, in the first stop mode, the control system 45 causes at least some of the transport vehicles 20 to stop on the second layer F2. As shown in FIG. 7, in the second stop mode, the control system 45 causes at least some of the transport vehicle 20 to stop on the second layer F2.

The control system 45 selects the first stop mode in response to an instruction from the operator for the maintenance of the transport vehicles 20. The control system 45 selects the second stop mode in response to an instruction from the operator for the maintenance of the floor E.

An article transport facility 10 according to a second embodiment will be described below with reference to the drawings. In the present embodiment, the floor E on which the multiple transport vehicles 20 travel includes a single layer, unlike in the first embodiment. The article transport facility 10 according to the present embodiment will be described below focusing on the differences from the article transport facility 10 according to the first embodiment. The components not described below are the same as those in the first embodiment.

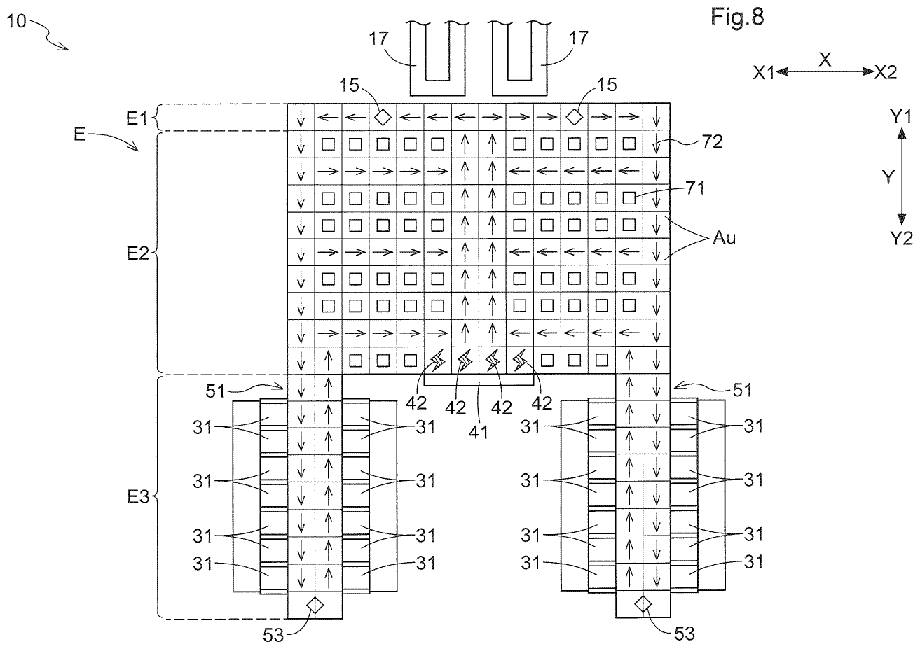

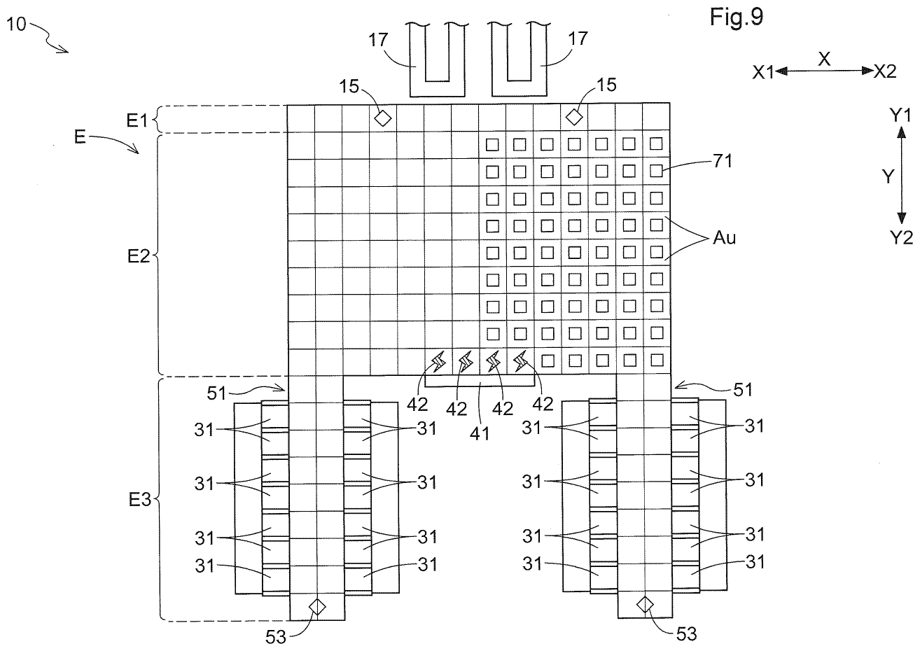

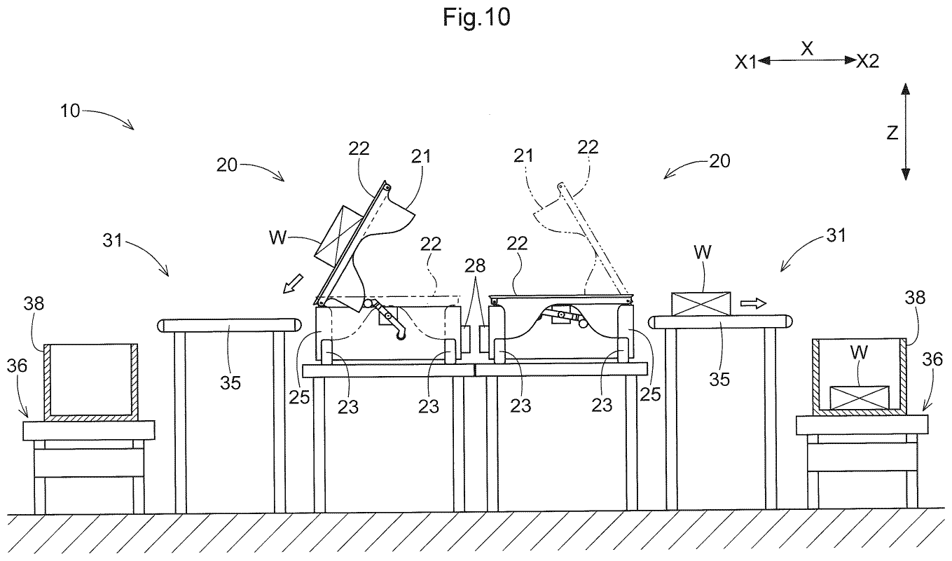

FIGS. 8 and 9 are top views of the article transport facility 10 according to the present embodiment. FIG. 10 is a front view of an aisle area E3 in the present embodiment. In the present embodiment, the article transport facility 10 includes turn positions 53 on the second side Y2 in the Y-direction relative to the first ends 51. In the example in the figures, the turn positions 53 are at the terminal ends of the aisle areas E3. The terminal ends of the aisle areas E3 are the ends of the aisle areas E3 on the second side Y2 in the Y-direction.

In the present embodiment, the outgoing path is defined by the transport command to cause each transport vehicle 20 to travel from the first end 51 to the turn position 53 in each aisle area E3. The return path is defined by the transport command to cause the transport vehicle 20 that has U-turned at the turn position 53 to travel from the turn position 53 to the first end 51 in the aisle area E3. The outgoing path and the return path are arranged adjacent to each other in the X-direction in each aisle area E3. In the present embodiment, as shown in FIGS. 8 and 10, the transport vehicles 20 transfer, on the outgoing path, the articles W to the receivers 31 disposed opposite to the return path in the X-direction in each aisle area E3, and transfer, on the return path, the articles W to the receivers 31 disposed opposite to the outgoing path in the X-direction in each aisle area E3.

FIG. 8 shows the arrangement pattern in the first stop mode. In the example in the figure, the control system 45 causes all the transport vehicles 20 that do not transport the articles W to stop in the connection area E2 in the first stop mode. In the example in the figure, the travelable areas 72 are arranged to define the travel paths in the form of a loop, on which the transport vehicles 20 that do not stop in the first stop mode travel back and forth between the supply units 15 and the receivers 31. This allows the operator to perform the maintenance of multiple transport vehicles 20, and allows, at the same time, multiple transport vehicles 20 to transport articles W from the supply units 15 to the receivers 31 to sort the articles W.

FIG. 9 shows the arrangement pattern in the second stop mode. In the example in FIG. 9, the control system 45 causes all the transport vehicles 20 that do not transport the articles W to stop in the connection area E2 in the second stop mode. In the present embodiment, the control system 45 equally divides the connection area E2 into parts, and uses one of the parts as the arrangement area in which the multiple transport vehicles 20 are proximate to each other.

An article transport facility 10 according to other embodiments will now be described.
(1) In the above embodiments, the article transport facility 10 is an article sorting facility, and includes the multiple supply areas E1, the connection area E2, and the multiple aisle areas E3 on the floor E. However, the structure is not limited to such an example. For example, the multiple aisle areas E3 may be replaced with a single aisle area E3. For example, the multiple supply areas E1 may be replaced with a single supply area E1. For example, the multiple supply units 15 may be replaced with a single supply unit 15. For example, the connection area E2 may be eliminated from the floor E. For example, the article transport facility 10 may not be a facility for sorting the articles W but may be a transport facility without the supply areas E1 and the aisle areas E3 on the floor E.
(2) In the above embodiments, the supply areas E1 and the connection area E2 are separated by the virtual boundaries, and each aisle area E3 has the two ends in the X-direction that are the outer edges of the floor E. However, the structure is not limited to such an example. For example, the supply areas E1, the connection area E2, and the aisle areas E3 may be defined by the actual outer edges of the floor E and may each be an area in which the transport vehicles 20 are movable. For example, the supply areas E1, the connection area E2, and the aisle areas E3 may all be virtually-defined areas on the large floor E. For example, the floor E may include areas different from the supply areas E1, the connection area E2, and the aisle areas E3, such as buffer areas in which multiple transport vehicles 20 can be in line.
(3) In the above embodiments, the control system 45 includes the host controller that controls the multiple transport vehicles 20 and the controllers mounted on the respective transport vehicles 20. However, the structure is not limited to such an example. For example, the control system 45 may be a system in which the controller on each transport vehicle 20 communicates with the controller on another transport vehicle 20 to autonomously determine the operation. For example, the floor E may include no position information holder. Position information about the transport vehicles 20 may be obtained by, for example, image sensors installed in the transport vehicles 20 or the facility.
(4) In the above embodiments, the control system 45 controls the transferrer 21 and the traveler 25 in each transport vehicle 20. However, the structure is not limited to such an example. For example, the controller 46 may control only the traveler 25 in each transport vehicle 20. For example, each transport vehicle 20 may not include the transferrer 21, and the operating entity 16 may transfer the article W on the transport vehicle 20. For example, the article W may be stored in a compartment included in the transport vehicle 20. For example, the control system 45 may control an operation device, which is the operating entity 16. For example, each transport vehicle 20 may not include the operable unit 28.
(5) In the above embodiments, the article transport facility 10 includes the supply transporters 17, the receiving transporters 35, and the shipping devices 36. However, the structure is not limited to such an example. For example, the article transport facility 10 may not include the supply transporters 17, the receiving transporters 35, or the shipping devices 36. An operator or a vehicle operated by the operator may transport the articles W or the containers 38.
(6) In the above embodiments, in the first stop mode and the second stop mode, at least some of the multiple transport vehicles 20 is in the connection area E2. However, the structure is not limited to such an example. For example, in the first stop mode and the second stop mode, all the transport vehicles 20 or some of the transport vehicles 20 may stop in the supply areas E1, the aisle areas E3, the first lifters L1, or the second lifters L2.
(7) In the above embodiments, the connection area E2 includes the charging positions 42 for charging the transport vehicles 20 with the charger 41. However, the structure is not limited to such an example. For example, the charging positions 42 may be arranged in other areas accessible to the supply areas E1, the aisle areas E3, and the connection area E2.
(8) In the above embodiments, in the second stop mode, the arrangement area in which the multiple transport vehicles 20 are arranged densely is changed in response to an instruction from the operator. However, the structure is not limited to such an example. For example, the arrangement area may not be changeable in the second stop mode.
(9) In the above embodiments, the first stop mode is automatically selected in response to the end of the transportation of the articles W by the transport vehicles 20. However, the structure is not limited to such an example. For example, the second stop mode may be automatically selected in response to the end of the transportation of the articles W by the transport vehicles 20. For example, the first stop mode and the second stop mode may be selected by the operator, instead of being automatically selected.
(10) The structure described in each of the above embodiments may be combined with any other structures described in the other embodiments unless any contradiction arises. The embodiments described herein are merely illustrative in all aspects and may be modified variously as appropriate without departing from the spirit and scope of the disclosure.

The article transport facility according to one or more embodiments of the disclosure will be described below.

In one aspect, an article transport facility is an article transport facility in which a plurality of transport vehicles travel on a floor to transport articles. The article transport facility includes a control system that controls the plurality of transport vehicles. The control system includes a first stop mode and a second stop mode each being a stop mode in which the plurality of transport vehicles do not transport the articles. The first stop mode is a mode in which the plurality of transport vehicles are arranged in a plurality of lines. At least one aisle on which the plurality of transport vehicles are travelable is defined between adjacent lines of the plurality of lines of the plurality of transport vehicles. All transport vehicles of the plurality of transport vehicles in each of the plurality of lines are adjacent to the at least one aisle. The second stop mode is a mode in which the plurality of transport vehicles are proximate to each other without the at least one aisle.

In this structure, the aisle is defined between the adjacent lines of the transport vehicles in the first stop mode. This allows, for example, the transport vehicles to move on the aisle for charging or an operator to move on the aisle for the maintenance of the transport vehicles. This facilitates the maintenance of the transport vehicles. In the second stop mode, the plurality of transport vehicles are proximate to each other, thus reducing an area on the floor in which the transport vehicles being stopped are arranged. This facilitates the maintenance of the floor. In this structure, as described above, in the stop modes in which the plurality of transport vehicles do not transport the articles, the transport vehicles can be arranged and stopped in different arrangement patterns based on, for example, the details of an operation, such as maintenance, performed by the operator or whether the transport vehicles are to be charged. The stop modes can thus be used more effectively.

In one aspect, the control system automatically selects the first stop mode in response to an end of transportation of the articles by the plurality of transport vehicles. The control system selects the second stop mode in response to an instruction from an operator for maintenance of the floor. In the second stop mode, the control system changes, in response to an instruction from the operator, an arrangement area in which the plurality of transport vehicles are proximate to each other.

In this structure, the first stop mode is automatically selected when a normal operation ends, thus allowing the operator to charge the transport vehicles or to perform the maintenance of the transport vehicles in the stop mode more easily. For the maintenance of the floor, the plurality of transport vehicles can be arranged in a predetermined arrangement area, and the arrangement area can be changed, thus allowing the operator to appropriately perform the maintenance of the floor more easily.

In one aspect, each of the plurality of transport vehicles includes an operable unit operable by an operator. In the first stop mode, each of the plurality of transport vehicles is disposed with the operable unit adjacent to the at least one aisle.

This structure allows the operator to easily perform an operation, such as the maintenance of each transport vehicle, in the first stop mode.

In one aspect, the floor includes a plurality of aisle areas, a supply area, and a connection area. The plurality of aisle areas extend in a Y-direction as a direction along the floor and arranged in an X-direction as a direction along the floor and perpendicular to the Y-direction. The supply area is disposed on a first side in the Y-direction relative to the plurality of aisle areas. The supply area includes a supply unit that supplies the articles to the plurality of transport vehicles. The connection area connects the plurality of aisle areas and the supply area to each other. The article transport facility further includes a plurality of receivers arranged along each of the plurality of aisle areas. The plurality of receivers receive the articles from the plurality of transport vehicles. In each of the first stop mode and the second stop mode, at least one of the plurality of transport vehicles is in the connection area.

In this structure, the connection area is connected to each of the plurality of aisle areas and to the supply area. This achieves, in the first stop mode and the second stop mode, a higher flexibility in selecting the destination of each transport vehicle after the stop modes are canceled, compared with when all the transport vehicles are stopped in, for example, the aisle areas other than the connection area.

In one aspect, the connection area includes a charging position at which the plurality of transport vehicles are chargeable with a charger.

This structure allows, in the first stop mode, the transport vehicles to move to one of the aisles between adjacent lines of the transport vehicles and reach the charger easily. The transport vehicles can thus be charged efficiently.

The article transport facility according to one or more embodiments of the disclosure may produce at least one of the effects described above. The technical features of the article transport facility according to one or more embodiments of the disclosure are applicable to an article transport method and an article transport program.

What is claimed is:

1. An article transport facility in which a plurality of transport vehicles travel on a floor to transport articles, the article transport facility comprising:
a control system configured to control the plurality of transport vehicles, the control system comprising a first stop mode and a second stop mode each being a stop mode in which the plurality of transport vehicles do not transport the articles,
wherein the first stop mode is a mode in which the plurality of transport vehicles are arranged in a plurality of lines, at least one aisle on which the plurality of transport vehicles are travelable is defined between adjacent lines of the plurality of lines of the plurality of transport vehicles, and all transport vehicles of the plurality of transport vehicles in each of the plurality of lines are adjacent to the at least one aisle, and
wherein the second stop mode is a mode in which the plurality of transport vehicles are proximate to each other without the at least one aisle.

2. The article transport facility according to claim 1, wherein:
the control system automatically selects the first stop mode in response to an end of transportation of the articles by the plurality of transport vehicles,
the control system selects the second stop mode in response to an instruction from an operator for maintenance of the floor, and
in the second stop mode, the control system changes, in response to an instruction from the operator, an arrangement area in which the plurality of transport vehicles are proximate to each other.

3. The article transport facility according to claim 1, wherein:
each of the plurality of transport vehicles comprises an operable unit operable by an operator, and
in the first stop mode, each of the plurality of transport vehicles is disposed with the operable unit adjacent to the at least one aisle.

4. The article transport facility according to claim 1, wherein:
the floor comprises:
a plurality of aisle areas extending in a Y-direction as a direction along the floor and arranged in an X-direction as a direction along the floor and perpendicular to the Y-direction,
a supply area on a first side in the Y-direction relative to the plurality of aisle areas, the supply area comprising a supply unit configured to supply the articles to the plurality of transport vehicles, and
a connection area connecting the plurality of aisle areas and the supply area to each other,
the article transport facility further comprises a plurality of receivers arranged along each of the plurality of aisle areas, the plurality of receivers configured to receive the articles from the plurality of transport vehicles, and
in each of the first stop mode and the second stop mode, at least one of the plurality of transport vehicles is in the connection area.

5. The article transport facility according to claim 4, wherein:
the connection area comprises a charging position at which the plurality of transport vehicles are chargeable with a charger.
